(19) United States
(12) Patent Application Publication
(10) Pub. No.: US 2020/0322675 A1
(43) Pub. Date: Oct. 8, 2020

(54) METHOD FOR CHANNEL DOWNLOADING FOR ZAPPING A DIGITAL CHANNEL IN ACCORDANCE WITH THE USER'S BEHAVIOUR

(71) Applicant: SAGEMCOM BROADBAND SAS, RUEIL MALMAISON (FR)

(72) Inventor: Edouard SOLT, RUEIL MALMAISON (FR)

(21) Appl. No.: 16/955,500

(22) PCT Filed: Dec. 4, 2018
(86) PCT No.: PCT/EP2018/083420

§ 371 Date: Jun. 18, 2020

(30) Foreign Application Priority Data
Dec. 19, 2017 (FR) 1762522

(51) Int. Cl. H04N 21/438; H04N 21/433; H04N 21/472; H04N 21/442; H04N 21/422

(52) U.S. Cl. CPC H04N 21/4384; H04N 21/4331; H04N 21/44218; H04N 21/44222; H04N 21/42222; H04N 21/472

(57) ABSTRACT

A method for channel downloading for zapping from one digital channel to another channel in a decoding member to decode a channel and to transmit it to a screen, the decoding member including a downloading module including an activity state, wherein the method includes in the activity state downloading a first viewing channel in an activity quality and another channel in parallel with the first channel, the downloading being done according to an activity bit rate. The downloading module further includes an inactivity state having a downloading inactivity bit rate lower than the activity bit rate. The method includes in the inactivity state, downloading the first channel in the activity quality, receiving a signal of a channel change early warning sign, changing the state of the downloading module by switching from the inactivity to the activity state when the signal of a channel change early warning sign has been received.

### TECHNICAL FIELD OF THE INVENTION

The present invention relates to a method for channel downloading for zapping on a digital television decoder in accordance with the user's behaviour. The object of the present invention is a method for reducing FCC (Fast Channel Change) network resources in accordance with the user's behaviour. The aim of the invention is notably to propose a method making it possible to reduce network resource consumption (bandwidth) when data are not necessary without impacting FCC functionality, that is to say while enabling the user to shorten the zapping time of certain digital decoders, without all the same causing a loss of quality of image displayed by all of the decoders managed by an operator.

Zapping time, or channel change time, designates the length of time that elapses between the transmission of a channel change command by a user of a digital television decoder, by means of an appropriate remote control member, and the actual display of the desired channel on the screen connected to the considered decoder. Channel is conventionally taken to mean what users call a television channel, for example a channel broadcasting in the course of the day programmes succeeding one another.

The field of the invention is, generally speaking, that of digital television decoders which broadcast channels in UHD (Ultra High Definition) or/and HD (High Definition) or/and SD (Standard Definition).

In the field of digital television, digital television decoders D are used, notably in order to access a set of television channels which are transmitted encrypted and which are decrypted within the decoder. Television decoders D are interface members, associated in the case of a channel via the Internet network with modem type devices, between systems for transmitting television signals, notably digital television signals in UHDTV format, and viewing monitors comprising a display member E. The monitor may comprise the decoding member D and the display member E comprising a screen. The decoding member D may also be connected to the monitor. The signals exchanged are usually digital signals, but a decoder D may also have analogue signal processing faculties.

The transmission means that transmit the television programmes to these decoders/receivers are either means of transmission via “Broadcasting” that is to say via satellite or TNT, or instead via the Internet network, also called “Broadbanding”, that is to say via Internet box or live via Internet site.

The invention will be more particularly described within the context of decoders D receiving a stream of signals via the Internet network thus by transmission by “Broadbanding”, but the implementation of the method according to the invention is not limited to this type of decoder D but to any channel decoding member D via the Internet network.

In the case of a transmission by Internet, the channels may thus be transmitted to the decoder D via the Internet network. The decoder D comprises reception means for receiving the transmitted signals and formatting means for transforming the signals received into signals applicable directly on command members of the display device E of the monitor which may be a television, or a screen or instead for example a video-projector.

The formatting takes place while respecting for each of the images to represent parameter tables. Different types of tables may be distinguished: IS (Information System) tables, PSI (Programme Specific Information) tables, NIT (Network Information Tables), EIT (Event Information Tables), PAT (Programme Association Tables), ACT (Access Control Tables) or instead PMT (Programme Mapping Tables), etc. In digital television, it is provided that the signals of parameters are transmitted in the stream (that is to say with the video signal itself) in data packets, also called data or packets.

The data packets of a channel are transmitted to the decoder by downloading, also called downloaded channel. The broadcast channel is thus downloaded in the decoder to enable the decoder to decode and to transmit applicable signals directly to the command members of the display device E for displaying on a screen the channel M.

Ultimately, a whole architecture of tables is thus distributed and the aim of the decoder is to reconstruct all the tables to have available adjustment information and information to visually show for users.

### Technological Background of the Invention

In the prior art, during decoding of a channel, other channels are also downloaded in order to be quicker during a zapping operation on a decoder D.

FIG. 1 shows a diagram of packet transmission between an IPTV provider and a user.

In this example, the IPTV provider F transmits data packets 1 of a channel N, these packets 1 go through routers R on a public network then arrive in the user's premises via an Internet box B also called modem, which retransmits to the decoder D the packets 1. The packets 1 are next decoded so that the display E, which may be a television, a video-projector etc., displays the channel N.

The non-compressed video bit rate in UHD is for example of 2388 Mb/s to 71663 Mkb/s according to whether it is UHD-1 (4K) or UHD-2 (8 k). It is thus known to compress the image to decrease the bit rate.

Today it is known to use data compression norms such as MPEG2, AVC (Advanced Video Coding), HEV (Hight Efficiency Video Coding) to make it possible to decrease the bit rate.

Despite this compression, the necessary bit rate for the 3 qualities of channels used in digital television today is:

For SD (Simple Definition) quality having a definition of 720×576 pixels, the necessary bit rate may vary between 1 Mbits/s and 3 Mbits/s.

For HD/Full HD (High Definition, having a definition of 1280×720 or 1920×1080 pixels) quality, the bit rate may vary from 4 Mbits/s to 15 Mbits/s.

For UHD (UHDTV1/UHDTV2) quality the definition is 3840×2160 pixels or 7680×4320 pixels), the bit rate may vary from 10 Mbits/s to 30 Mbits/s (see hereafter).

When the user U performs an action leading to a channel change signal there is a waiting time, hereafter called zapping time TZ, between the new channel request operation and the display of the new channel.

A zapping action 100 leading to a channel change signal 101 to the decoder D is going to lead to a succession of steps described below in relation to FIG. 1. Such an action is for example pressing on one or more appropriate buttons of a remote control associated with the decoder, for example pressing on a “P+” or “CH+” button of the remote control.

A first step then resides in the taking into account, by the operating software of the decoder D, the action of the user.

A second step IGMP then follows wherein the decoder D is going, following the signal, to send two items of information, one item of information concerning the fact of leaving the channel and the other to receive the requested channel, in this case the channel M, to the IPTV provider. The decoder IP thus executes a so-called “command IGMP join” command, in this case the channel M, and a so-called “command IGMP leave” command, in this case the channel N.

The duration of this step corresponds to a connection time of the decoder, the time required, from the execution of the “command IGMP join”, to receive the first appropriate data packets extracted from one or more signal stream(s).

The provider is next going, in a third step, to send the data packets 2 concerning the channel M to the premises of the user U, that is to say to the Internet box B which is going to transmit these data to the decoder D.

Thus a time period, hereafter called downloading latency LT, is defined between the initial instant (t=0) as being the instant where the user performs the zapping action 100 to change channel and the instant where the decoder D has received the necessary packets for the display of the channel M, i.e. in this case the three steps described above.

When the decoder comprises all the data necessary for the display of the channel, a step of decoding and buffering follows, in which the decoder D decodes and buffer memorises the data 2 to be synchronised on a display image of the stream and to build up data 2 to be resistant to fluctuations of the network and finally a step of sending applicable signals directly to the command members of the display device E for displaying on a screen the channel M.

Thus a time period, hereafter called channel change latency LCC, is defined between the instant of the first packets 2 of the channel M received in the decoder D and the sending of applicable signals to the command members of the display device E.

The zapping time TZ is thus the channel change latency LCC and the downloading latency LT.

FIG. 2a represents a simplified channel change timing diagram, beginning by the channel N watched and ending on the channel M.

In this FIG. 2, an action of zapping 100 from a channel N to a channel M is performed by the user. In this example, the zapping time TZ corresponds to the sum of the downloading latency LT, which is according to the cases around 1 to 2 seconds in the case of a UHDTV channel, and the channel change latency LCC, which is less than 0.5 seconds.

This zapping time TZ may be problematic for the user, especially if it exceeds the 2 seconds recommended by the DSL Forum in terms of the required user QoE (Quality of Experience).

Channel downloading methods thus exist consisting, as in FIG. 2b, in downloading several channels at the same time, of which obviously that watched.

Thus, as may be seen in FIG. 2b, during the transfer of signals from the decoder D to the command members of the display device E for displaying on a screen the channel M, at least one other channel is downloaded (thus packets 2 of at least one channel are transmitted to the decoder), in this case two other channels: the channel N+1 corresponding in our example to the channel M and the channel N−1, hereafter called channel O.

During the action of zapping 100 from the channel N to the channel M, the zapping time corresponds uniquely to the channel change latency LCC since the channel M is already downloaded. It follows that the decoder D sends the applicable signals to the command members of the display device and the user waits less than 0.5 seconds to see the channel M on the display member E.

The channel N continues in this example to be downloaded and a channel L corresponding to the channel M+1 or N+2 is downloaded at the same time as the channel M.

It follows that the decoder takes an important part of the bandwidth of the Internet box B. Indeed, the downloading bit rate of packets (of all of the channels downloaded) for the decoder is in this example the equivalent of three times the bit rate for downloading a single channel.

In the case where the channels L, M, N or the channels M, N, O are channels having a UHD quality, for example UHDTV1, the total bit rate may thus vary between 30 Mbits/s to 90 Mbits/s (see hereafter).

Thus, in the user's premises, in a case for example of an Internet box B having a maximum downloadable bit rate of 100 Mbit/s, little bit rate remains for another device for another use on the Internet, for example network games, streaming, etc.

One of the solutions may be to download uniquely the channel N and to download several other channels uniquely when the user is in the course of zapping, that is to say a multitude of channel changes. FIG. 2c represents such a solution. Thus, when the user performs the zapping action 100 after a long viewing of channel N, the zapping time ZT corresponds to that of FIG. 2a, that is to say the sum of the downloading latency LT of the channel requested by the user and the channel change latency LCC. For a certain time, the channels M+1 and M−1, that is to say the channel N, are downloaded at the same time as the channel M, as in the example of FIG. 2b. Thus, if the user once again performs the zapping action 100, for example a second time by pressing on the “+” button of the remote control, the zapping time ZT will be that of the channel change latency LCC, as in the example of FIG. 2b.

However, as already mentioned, the zapping time ZT is an important parameter in the appreciation of the quality of services provided by an operator. This quality is regularly evaluated by an important organisation. It is thus advisable to properly look after this characteristic of decoders, a characteristic directly appreciable by the final user.

There thus exists a need to optimise the zapping time ZT while reducing the total bit rate downloaded by the decoder.

### General Description of the Invention

The method according to the invention proposes a solution to the problems and drawbacks that have been described above. In the invention, a solution is proposed enabling an optimisation between the reduction of the bandwidth used by the decoder to enable another use of the bandwidth between the portal of their operator and their reception means when a channel is watched from a certain time and the reduction in zapping time when the user shows precursor signs of a possible zapping action.

To this end, in the invention, it is proposed to switch from an inactivity state to an activity state after reception of a precursor or early warning signal of an action of the user of a change of channel.

The invention thus essentially relates to a method for channel downloading for zapping from one digital channel to another digital channel in a decoding member configured to decode a channel and to transmit it to a screen, the decoding member comprising a downloading module comprising an activity state,

wherein the method comprises, in the activity state, a step of downloading a first viewing channel in an activity quality and at least one other channel in parallel with the first channel, the downloading being carried out according to an activity bit rate,

the downloading module further comprising an inactivity state having a downloading inactivity bit rate lower than the activity bit rate, wherein the method comprises the steps of:
downloading the first channel in an activity quality,
receiving a signal of channel change early warning sign,
changing the state of the downloading module by switching from the inactivity state to the activity state when the signal of channel change early warning sign has been received.

Thus, in the activity state the downloading module downloads channels such as for example in the example of FIG. 2b. The fact that the bit rate is lower in the inactivity state than in the activity state allows that in the event of saturation of the bandwidth in the activity state the bandwidth may not be saturated in the inactivity state. Indeed, in the inactivity state other products may download according to a higher bit rate than in the activity state. This avoids a degradation of another use with another product on the Internet. The fact of switching from the inactivity state to the activity state potentially before a channel change request makes it possible to decrease the zapping time.

Inactivity bit rate lower than activity bit rate is taken to mean the bit rate for downloading the same channel in the two states, as well as the at least one channel downloaded in parallel in the activity state. For example, a viewing channel is downloaded in the activity state with other channels downloaded in parallel according to an activity bit rate greater than the inactivity bit rate of the same viewing channel downloaded in the inactivity state.

Thus, the invention optimises the use of the downloading of a channel in the inactivity state to reduce the bandwidth while reducing the average zapping time while switching back to the activity state before a channel change request.

Obviously, the zapping time, as in the case of the prior art, is not reduced if the channel requested by the user is not the at least one channel downloaded in parallel.

Obviously, by inactivity state of the downloading module, the decoder is not in sleep mode but is in a state of use using a lower bit rate than in the activity state.

In the activity state, the step of downloading at least one other channel in parallel with that transmitted in the activity quality is carried out during the steps of decoding and transmission of the first channel which is decoded. These steps of decoding and transmission are described hereafter.

The downloading of several channels may be achieved by several operations of downloading streams in parallel, one stream per channel.

The downloading method may further comprise a step of determining the end of activity state to switch from the activity state to the inactivity state.

The determination step may comprise different operations consisting in:
measuring an idle period in the activity state consisting in measuring the time elapsing from a change of channel or from the reception of a signal of channel change early warning sign,
comparing the measured idle period with at least one memorised reference threshold value.

The reference threshold value may be memorised in a memory of the decoder, for example in the downloading module.

The determination step may further comprise an operation consisting in:
receiving an activity signal,
reinitialising the idle period measurement at each reception of an activity signal.

The measured idle period is reinitialised at each activity signal received. The activity signal comprises at least one channel change signal but may also be:
a signal of detection of a channel change early warning sign by the user to switch from the inactivity state to the activity state, and/or
a channel change signal received originating from originally of the user, for example by pressing a “P+” or “CH+” button on the remote control.

According to an example, the action of measuring an idle period is a countdown having a reference threshold value, for example of 15 minutes.

The downloading method may further comprise a change of state step, from the activity state to the inactivity state, when the idle period is longer than the at least one reference threshold value.

Thus, when the user performs the zapping action, the decoder receives a channel change signal originating from the zapping action, for example on a remote control, and measures the idle period from this change of channel. At each change of channel the idle period is reinitialised.

According to an example, the reference threshold value is chosen in a range between five and twenty minutes, notably fifteen minutes.

The signal of early warning sign may comprise a signal sent by a remote control member to the decoder, notably a signal from a displacement sensor of the remote control member.

The displacement sensor may for example be an accelerometer or a gyroscope.

For example, the acceleration sensor may measure an acceleration due to the displacement of the remote control member.

The method may comprise a step of detecting a signal of early warning sign when an acceleration signal received is greater than or equal to a threshold signal representative of an acceleration of 0.3 g, preferentially greater than 0.5 g. 1 g is equal to 9.81 metres per second i.e. 0.3 g is equal to 0.3*9.81 m/s, i.e. 2.94 m/s.

For example, the method may comprise a step of comparison of an acceleration signal received with at least one threshold signal representative of an acceleration of 0.5 g and in that if the acceleration signal is greater, a signal of early warning sign of change of sign is considered detected.

The decoding member may comprise a user behaviour analysis module configured to carry out this comparison step. This behavioural analysis module may further be configured to carry out the step of detecting a signal of early warning sign.

In the case where the remote control is configured to carry out the comparison step, the method further comprises a step of sending a signal of early warning sign to the decoder uniquely if the acceleration signal measured by the sensor is greater than a threshold value, for example 0.5 g.

This makes it possible to determine a change of orientation of the remote control by the user and thus a possible zapping action of the user.

The signal of early warning sign comprises a signal originating from a measurement of the remote control sensor indicating at least one acceleration of 0.5 g or at least 1 g.

The decoder may determine that a signal originating from the remote control member indicating at least one acceleration of 1 g is an early warning signal of a change of sign.

According to an example, an activity signal corresponds to a signal originating from a measurement of the remote control sensor indicating at least one acceleration of 0.5 g and a signal of early warning sign to switch from the inactivity state in the activity state comprises a signal originating from a measurement of the remote control sensor indicating at least one acceleration of 1 g.

This makes it possible to determine a pick-up of the remote control by the user.

Thus, the decoder could dissociate a signal of the remote control originating from the accelerometer representing an acceleration less than for example 0.3 g being able to be a displacement of the support of the remote control.

The signal of early warning sign sent by the remote control member may comprise a signal of a pressing on a request button of the remote control member. Obviously, it is not a button changing channel because that would no longer be a channel change early warning sign.

In other words, the remote control member comprises channel change buttons on the one hand and on the other hand request buttons, such as for raising or lowering the sound volume, information, direct recording, etc. Pressing on the “off” button for placing the decoding member in sleep mode obviously cannot be interpreted as a channel change early warning sign.

The signal of early warning sign may also comprise a signal received from a microphone corresponding to a key word. Key word is taken to mean one or more words of a key phrase. For example, the key word may be the start of a phrase for opening an application in the decoding member.

For example, the signal may be a key word or phrase for triggering the decoding member.

The signal of early warning sign may also be a detection of advertising in the channel. For example the detection may be realised by an increase in the volume in the decoding of packets.

According to another embodiment, the signal of early warning sign stems from an action on the decoder or an accessory of the decoder only being able to originate from the user. For example, a displacement of the remote control comprising a movement sensor or instead an enumerated key word captured by a microphone of the decoding member or instead a request button pressed on the remote control or the decoding member. The request button not being able to be a button changing programme.

The signal of early warning sign may also be the opening of an application of a remote control member. For example in the case of a smartphone, it is the opening of a remote control application to command the decoder which sends an application opening signal to the decoder and which is taken into account as a signal of early warning sign. The passage of the application from a sleep state to an activity state may also be a signal of early warning sign.

According to an embodiment being able to be combined with the different examples described previously, in the inactivity state the number of channels downloaded by the downloading module is a single channel. The first part of the downloading of the first channel of the inactivity bit rate may thus correspond to the inactivity bit rate. In other words, in the inactivity state, the downloading carried out by the decoder is of a single channel. There is no other channel downloaded in this embodiment than the channel decoded in the inactivity state.

According to an embodiment other than the preceding embodiment described, being able to be combined with the different examples described previously, in the inactivity state the method further comprises a step of downloading at least one other channel in parallel with the transmitted channel, the transmitted channel using a first part of the inactivity bit rate and the at least one other channel in parallel using a second part of the inactivity bit rate, and in that the second part of the inactivity bit rate being lower than the second part of the activity bit rate for downloading at least one other channel in parallel in the activity state. The downloading of the other channels may either be in a lower quality or not complete or less numerous than in the activity state.

Second part of the inactivity bit rate being lower than the second part of the activity bit rate is taken to mean that the bit rate of the channel(s) downloaded in parallel in the inactivity state is one of the channels downloaded in parallel in the activity state.

Thus, in the event of a channel change press of the user without detection of early warning sign, the zapping time is decreased if the channel requested by the user is one of the channels downloaded. For example such a case may occur by pressing on a button changing channel without displacement of the remote control.

The invention also relates to a method for broadcasting a downloaded channel to be able to send signals to command members of a display device, the broadcasting method comprising the downloading method described previously according to the different examples or embodiments, wherein the decoding member comprises an output and the broadcasting method further comprises a step of decoding the first channel and a step of transformation into signals transmitted to the output to transmit signals to command members of a display device for displaying the first channel.

In the activity state, the broadcasting method comprises the steps of decoding the first channel in the first quality by the decoding member and placing in buffer memory the decoded data of the channel, in other words the decoded channel.

In the inactivity state, the broadcasting method may comprise a step of decoding the channel downloaded in activity quality.

In the activity state, the broadcasting method further comprises a step of transmission of the first decoded channel in the first quality to the output of the decoder for sending applicable signals directly to the command members of the display device for displaying on a screen the channel.

In the inactivity state, the broadcasting method comprises a step of transmission of the first decoded channel in activity quality to the output of the decoding member for sending applicable signals directly to the command members of the display device for displaying on a screen the first channel,

The broadcasting method may further comprise a step of recording in a buffer memory decoded data of the first decoded channel. In other words, recording in a buffer memory the decoded channel for viewing.

According to an embodiment, the broadcasting method comprises, in its decoding step, the decoding of all the channels in the activity state. In this embodiment, the method comprises the step of recording in a buffer memory the decoded data of the first channel but also the decoded data of other channels downloaded in parallel.

The invention also relates to a method for zapping a channel comprising the broadcasting method described previously, wherein the zapping method comprises the steps of:
receiving a signal of change of requested channel, then
changing the decoded channel to the requested channel as a function of the signal of change of requested channel.

The change of requested channel is done by interrupting the transmission of the decoded channel then by the steps of decoding and transmission of the requested channel.

Obviously, the change of channel is possible in the two states of the decoder (of activity or of inactivity). In the case of activity, the change of channel will be done with a zapping time corresponding to the channel change latency if the channel requested by the user corresponds to the channel or channels downloaded in parallel with the decoded channel before the change of channel.

The channels downloaded in parallel with the decoded channel may be for example:
the following channel and the preceding channel, or/and
a regularly decoded channel, in particular a channel regularly watched at a certain time.

The invention also relates to a decoding member implementing a downloading method with or without the different examples or embodiments described previously or/and the zapping method described previously, the decoding member comprising a downloading module.

The invention also relates to a “computer programme” product directly loadable in an internal memory of a decoding member, comprising software code portions which, when said programme is executed, lead said programme to implement all the steps of the downloading method with or without the different examples or embodiments described previously.

The invention also relates to a “computer programme” product directly loadable in an internal memory of a decoding member, comprising software code portions which, when said programme is executed, lead said programme to implement all the steps of the zapping method described previously.

The invention also relates to a data recording support readable by a machine comprising a processor, comprising one of the two computer programmes described previously.

The invention also relates to a decoding member comprising a programme memory configured to implement the channel downloading method described previously or one of the two computer programmes described previously.

The decoding member may be a decoder or a tablet or instead a computer.

The invention also relates to an assembly comprising a decoding member described previously and a remote control member comprising an accelerometer sensor able to send a signal of early warning sign to switch the downloading module from the inactivity state to the activity state.

The remote control member may be a remote control by wave or a smartphone comprising an application of remote control of the decoder.

The different additional characteristics of the method according to the invention, in so far as they are not mutually exclusive, are combined according to all possibilities of association to end up with different exemplary embodiments of the invention.

The present invention also relates to a digital television decoder able to implement the method according to the invention, with its main characteristics, and potentially one or more additional characteristics that have been mentioned.

The invention and its different applications will be better understood on reading the description that follows and be examining the figures that accompany it.

### BRIEF DESCRIPTION OF THE FIGURES

These are only presented for indicative purposes and in no way limit the invention. The figures show:

FIG. 1, already described, represents a diagram illustrating the proceeding of a zapping sequence for a digital television decoder receiving a conventional steam of signals via the Internet network;

FIGS. 2a to 2c, also already described, each represent a timing diagram illustrating the proceeding, in the prior art, of a zapping sequence for a digital television decoder receiving a stream of signals via the Internet network;

FIG. 3, a schematic representation of the operation of a digital television network enabling the implementation of an example of the method according to the invention;

FIG. 4 represents a flow diagram of an example changing the state of the decoder.

FIGS. 5a to 5c each represent a timing diagram of an embodiment of the invention.

FIG. 6 represents a “Grafcet” sequential function chart illustrating a method for channel downloading according to an embodiment.

### DESCRIPTION OF PREFERRED EMBODIMENTS OF THE INVENTION

Unless stated otherwise, the different elements appearing in several figures will have kept the same reference.

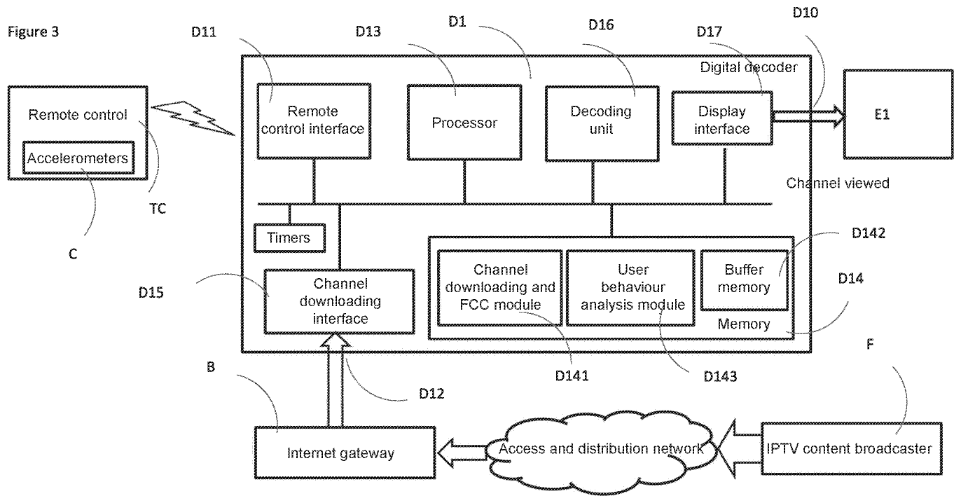

FIG. 3 schematically represents an operation of a digital television network enabling the implementation of an example of the downloading method according to the invention in a decoding member of type decoder D1 according to the invention.

The decoder D1 comprises an output D10 connected to a television E1. The decoder D1 comprises a signal sensor not represented and a remote control interface D11 for reading the signals received on the sensor originating from a remote control Tc. The remote control Tc comprises a movement sensor C, in this case an accelerometer.

The decoder further comprises an input D12 connected to an Internet box B, also called Modem, making it possible to ensure the Internet gateway function between the public network and the private network.

An IPTV provider F transmits by Internet to the Internet box B data packets of television channel(s).

The Internet box B transmits these data to the decoder D1 via its input D12. The decoder D1 sends channel downloading requests to the provider F. The decoder thus downloads data packets of one or more channels. This downloading is carried out according to a bit rate, that is to say a measurement of the amount of digital data transmitted per time unit, in this case in Megabits per second.

The decoder D1 is configured to download the channels according to a channel downloading method.

To do so, the decoder comprises a processor D13 and comprises a memory D14. The decoder comprises a module for downloading D141 channels in the memory D14. The downloading module D141 comprises an activity state and an inactivity state.

In the two states, the decoder D1 comprises a downloading interface D15 used by the downloading module D141 for downloading at least one channel M viewed, and can further download channels in parallels therefrom. Downloading a channel is taken to mean downloading the data packets of a channel.

The decoder D1 is further configured to carry out a method for broadcasting the downloaded channel N. The broadcasting method comprises a step of decoding the downloaded channel N. The channel N is decoded by a decoding unit D16. The broadcasting method further comprises a step of transformation of the decoded channel into signals directly transmissible to the command members of the television E1. The decoded channel is transformed by a display interface D17 of the decoder D1. The television EI may thus display on a screen the channel N. The decoder D1 is thus configured to transmit these signals via its output D10 to the display member E.

The decoder D1 is thus configured to carry out the channel downloading method comprising a step of receiving a stream of one channel or several channel streams in parallel. The quality of the downloaded channels may be different.

The method for downloading in the downloading module comprises in the activity state a step of downloading a first viewing channel N in an activity quality, for example UHD. The downloading of this channel N requires a first bit rate, for example 25 Mb/s megabits per second, also called bandwidth.

FIG. 5a represents a timing diagram of an example of channel downloading when the downloading module is in an activity state and a switch to the inactivity state.

A channel N is requested to be viewed, that is to say that a user requests to view a channel. The packets of the channel N are downloaded. A downloaded channel is taken to mean that the packets of a channel are downloaded.

The downloading module D141 further comprises in its step of downloading the viewed channel the downloading in parallel of two other channels. In this case, the two other downloaded channels are the channel N+1, that is to say the channel M, and the channel N−1, that is to say a channel designated O.

The downloading of at least one channel N other than the first decoded channel M, in this case the two channels O and M, each also necessitates a bit rate for example of 25 Mb/s. The downloading of three channels thus necessitates 75 Mb/S of bit rate.

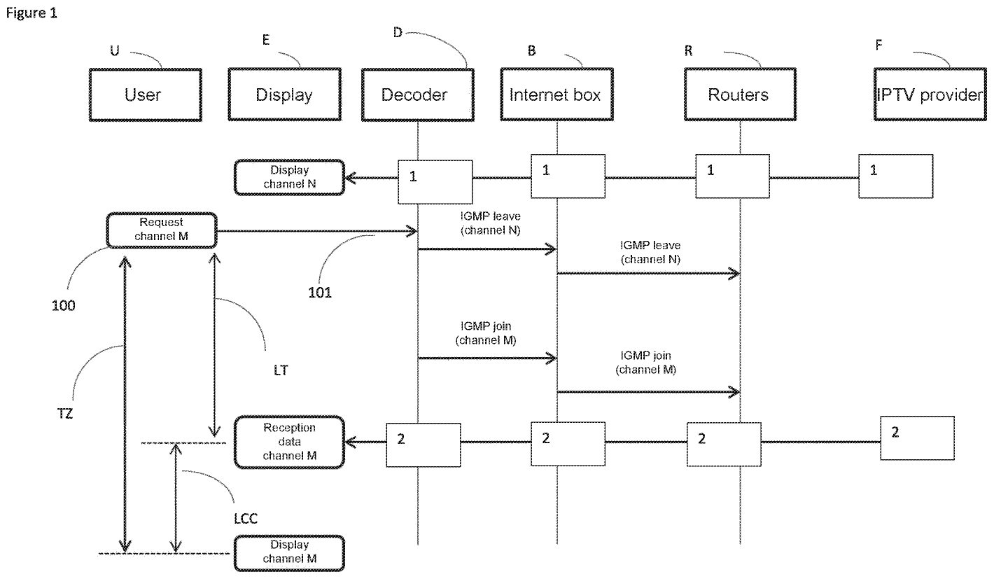

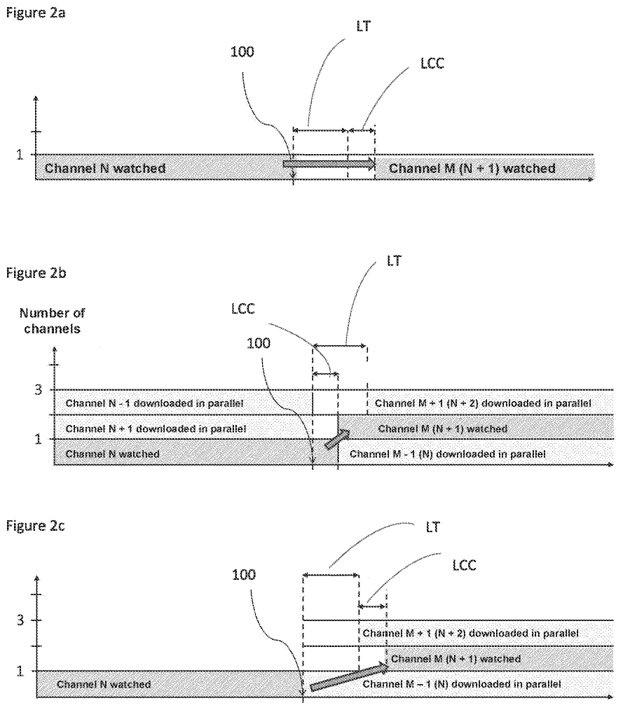

Thus, in the activity state the downloading module downloads the channels in period of activity such as for example in the example of FIG. 2b.

It follows that during this activity time, if the user performs an action of requesting a change of channel 100 and that one of the channels is the channel N+1, i.e. the channel M, the channel change time will be uniquely the channel change latency LCC. Obviously, the zapping time is not reduced if the channel requested by the user is not one of the channels downloaded in parallel with the channel viewed in the activity state of the decoder.

The decoder is also configured to switch from the activity state to the inactivity state. In FIG. 5a, an action of end of activity 102 is determined, it follows that the decoder D1 switches from the activity state EA to the inactivity state EI.

The determination of end of state may be a step of the channel downloading method carried out by the downloading module but could also be carried out by another module of the decoder.

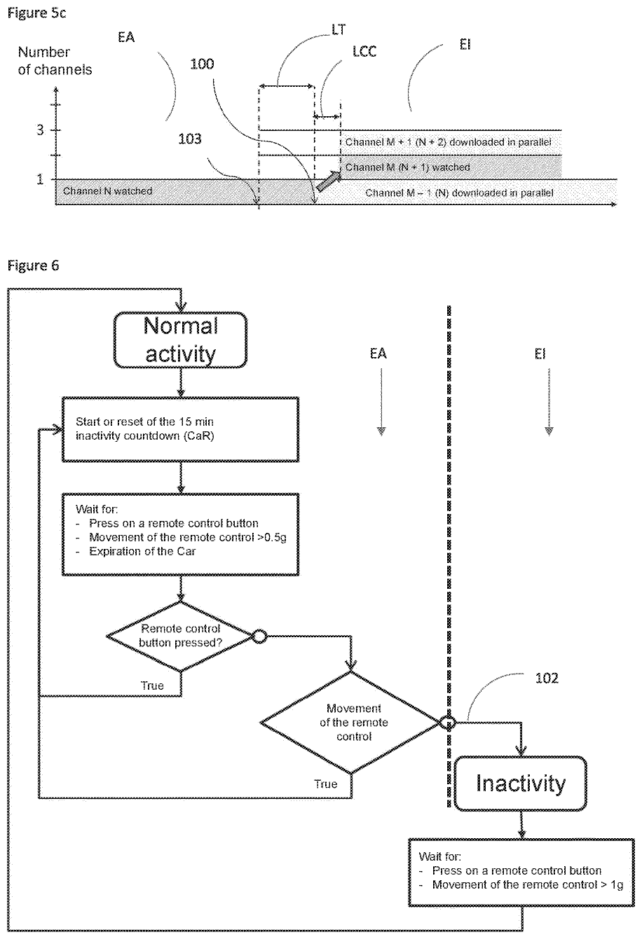

The determination step may comprise different operations. FIG. 6 represents a step of determination of end of state comprising an action of measuring an idle period in the activity state. In this case, the action of measuring an idle period is a countdown CaR having a reference threshold value, in this case 15 minutes. This could also be a time delay, and the idle period may be between 5 and 20 minutes for example. The reference threshold value may be memorised in a memory of the decoder, for example in the downloading module.

The countdown measures the time elapsing from a change of channel or from a switch from the inactivity state to the activity state from a memorised reference threshold value, which is in this case 15 minutes. Thus, the countdown compares the measured idle period with the threshold value of 15 minutes.

The countdown is reinitialised at each activity signal. FIG. 6 shows examples of activity signal. The activity signal comprises signals received originating from the base of the user. In this case, the activity signal comprises a signal of pressing on a button To of the remote control TC and a signal of movement of the remote control TC originating from the movement sensor C.

Thus, when the user performs the zapping action 100, the decoder receives a channel change signal 101 originating from the zapping action, for example from a remote control, and measures the idle period from this change of channel. At each change of channel, the idle period is reinitialised.

If, during the 15 minutes, the decoder has not received any activity signal, the downloading module detects an end of state 102 and switches from the activity state EA to the inactivity state EI.

The downloading module is configured in the inactivity state to continue to download the first channel M viewed. The quality may be identical or may be improved. The downloading in the inactivity state EI of a single channel N may be carried out in a unicast stream. When the method switches to the activity state EA, the downloading of the channels N, N+1 and N−1 may be carried out while downloading several streams in parallel.

FIG. 5a shows in this example that only the channel N continues to be downloaded (the other channels N+1 and N−1 are no longer downloaded).

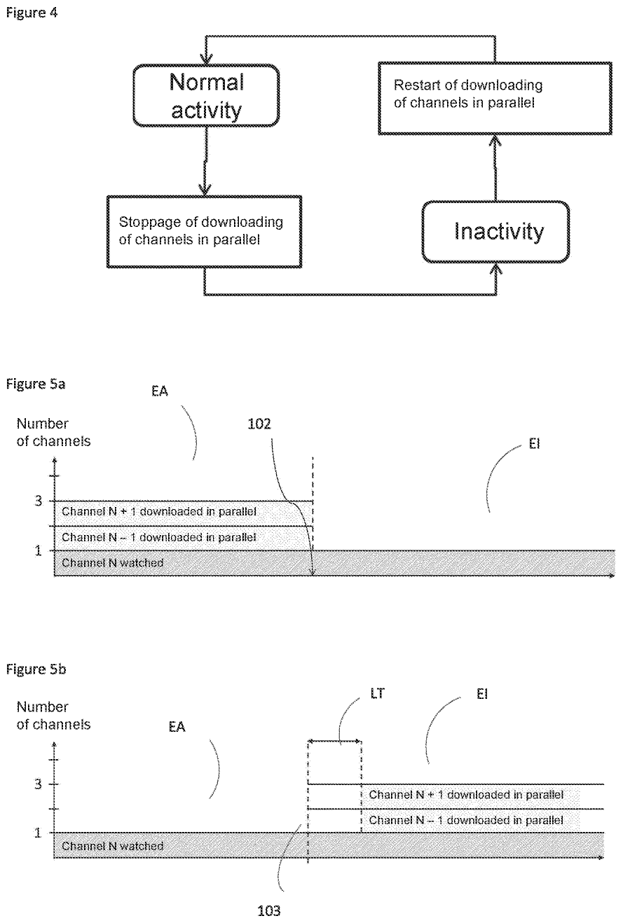

FIG. 4 represents an example of flow chart changing the state of the downloading module D141 of the decoder D1. During the switch from the inactivity state to the activity state, there is a restart of downloading of channels in parallel and during the switch from the activity state to the inactivity state, there is a stoppage of downloading of channels in parallel.

In this inactivity state EI, the decoder decodes the channel N in the decoding unit D16 and records in a buffer memory D142 the decoded channel N, to be retransmitted by means of the display interface D17 into signals at the output D10 applicable by the display device E1.

Thus the bit rate for channel downloading switches from 75 Mbit/s to 25 Mbit/s.

Thus, if another product such as a video games console or a computer using the same Internet box B requires a resource of 30 Mbit/s for example, the necessary bit rate in the box will go from the activity state 105 Mb/s to 55 Mbit/s. In the case where the box cannot go beyond a bit rate of 100 Mbit/s, there is thus a risk of saturation of the bandwidth.

The loading method further comprises the steps in the inactivity state of:
receiving a signal of a channel change early warning sign 103 by the user
changing the state of the downloading module by switching from the inactivity state to the activity state when a signal of channel change early warning sign 103 has been received.

The downloading module may be configured to receive a signal of channel change early warning sign 103 by the user and to change by switching from the inactivity state to the activity state when a signal of channel change early warning sign 103 has been received.

The signal of early warning sign 103 may be sent by the remote control member TC. The signal of channel change early warning sign 103 may comprise a signal of pressing on a request button of the remote control member or a signal of the position sensor C. Obviously, the signal of channel change early warning sign 103 cannot be a channel change button because it would no longer be a channel change early warning sign. In other words, the remote control member TC comprises channel change buttons on the one hand and on the other hand request buttons, such as for raising or lowering the sound volume, information, direct recording, etc. Pressing on the “off” button to place the decoding member DC in sleep mode obviously cannot be interpreted as a channel change early warning sign.

For example, the acceleration sensor can measure an acceleration of the displacement of the remote control member and send an acceleration signal to the decoder.

The method may comprise a step of detecting a signal of early warning 103 when an acceleration signal received is greater than or equal to a threshold signal representative of an acceleration of 0.3 g, preferentially greater than 0.5 g or 1 g.

The decoder comprises in this case a user behaviour analysis module D143 to carry out the step of detecting a signal of channel change early warning sign 103 by the user. The downloading module D141 receives the signal of channel change early warning sign 103 from the detection module D143.

For example, the method may comprise a step of comparison of an acceleration signal received with at least a threshold signal representative of an acceleration of 0.5 g and in that if the acceleration signal is greater than the threshold signal, a signal of channel change early warning sign 103 is considered as detected.

The user behaviour analysis module D143 is in this case configured to carry out this comparison step.

According to another embodiment, not represented, the remote control is configured to carry out the step of comparison, the method further comprises a step of sending a signal of early warning sign to the decoder uniquely if the acceleration signal measured by the sensor is greater than a threshold value, for example 0.5 g or at least 1 g. This makes it possible to determine a pick-up of the remote control by the user.

According to an embodiment not described, the decoding member comprises a microphone. The signal of early warning sign 103 may comprise in this case a signal received from a microphone to open an application in the decoding member DC. For example, the signal may be a key word or phrase to trigger the decoding member. The microphone may be, according to another example not represented, in the remote control.

The signal of early warning sign may also be a detection of advertising in the channel. For example, the detection may be carried out by an increase in the volume in the decoding of packets.

Thus, the downloading module switches from the inactivity state EI to the activity state EA. FIG. 5b shows the case of a signal of channel change early warning sign 103 without the user having changed channel. In this case, the downloading module switches to the activity state from this signal of channel change early warning sign 103 received and, after a downloading latency, the channels N+1 and N−1 are downloaded. The countdown thus measures an idle period and if the user does not perform any action, notably on the remote control, no activity signal is sent. After the idle period, in this case fifteen minutes, the downloading module switches back to the inactivity state.

However, in the case where a signal of channel change early warning sign 103 is a precursor of a channel change by the user, the switching over in advance to the activity state EA for the loading of channels make it possible to decrease the zapping time TZ.

FIG. 5c represents such a case, for example, the user picks up his remote control TC and thus the displacement sensor identifies a change of orientation of the remote control by the user representative of a signal of channel change early warning sign 103 and next presses on a “P+” button, also called “CH+” button, of the command TC to zap to the following channel M (N+1).

FIG. 5c, shows that after having detected the signal of channel change early warning sign 103, a zapping action 100 during the activity state EI leads to a channel change signal 101. The channel M being downloaded, the zapping time TZ then corresponds only to the channel change latency LCC. A zapping method is next described explaining how the channel change is carried out.

The channel M having become the first channel, the channels downloaded in parallel become the channel M+1 corresponding to channel N+2 and the channel N (M−1) continues to be downloaded.

According to an embodiment, not represented, the decoder D1 may receive signals from a smartphone, and in that the signal of early warning sign comprises the opening of a remote control application in the smartphone to be used as remote control. The remote control application may command the decoder D1.

During the opening of the application, the smartphone sends an application opening signal to the decoder D1 and which is determined as a signal of early warning sign 103.

According to another embodiment, not represented, in the inactivity state, the downloading module is configured so that the method further comprises in the step of downloading the channel M the downloading of a single other channel in parallel, for example N+1. In other words, the number of channels downloaded in the activity state is greater, in this case three, than the number of channels in the inactivity state, in this case two channels. Thus, this makes it possible to decrease the bandwidth in the inactivity state. The bit rate is thus lower in the inactivity state than in the activity state.

According to another embodiment, not represented, in the inactivity state, the downloading module is configured so that the downloading method further comprises in the step of downloading the channel M the downloading of at least one of the other channels downloaded in parallel in the activity state but in a quality inferior to the quality in the activity state.

Thus, in the event of a channel change press of the user without detection of early warning sign, the zapping time is decreased if the channel requested by the user is one of the downloaded channels.

The decoder D1 comprises a method for zapping a channel comprising the downloading method according to one of the embodiments described as well as the broadcasting method described previously and a step of reception of the requested channel change signal 101 then a step of changing the decoded channel N to the requested channel M as a function of the channel change signal 101. The change of channel takes place by interrupting the decoding and the transmission of the decoded channel N then by carrying out the steps of decoding and of transmission of the requested channel M.

The decoder D thus executes a so-called “command IGMP join” command, in this case the channel M, and a so-called “command IGMP leave” command, in this case the channel N, to the provider via Internet.

Obviously, the change of channel is possible in the two states of the decoder D1 (of activity or of inactivity). As explained above, in the case of activity state EA, the change of channel will be done with a zapping time TZ corresponding to the channel change latency LCC if the channel M requested by the user corresponds to the channel or channels downloaded in parallel with the decoded channel N before the reception of the channel change signal 101.

In the case of inactivity state, if there is no channel downloaded in parallel as in the example represented, the zapping time TZ will correspond to the sum of the downloading latency LT and the channel change latency LCC.

In the example described, the decoding member is a decoder but could be a tablet or instead a computer.

In the example represented, the channels downloaded in parallel with the decoded channel are the following channel N+1 and the preceding channel N−1. According to another embodiment, not represented, the channels downloaded in parallel are channels other than the channels following and preceding the channel viewed. For example, the user behaviour analysis module may detect and memorise a regularly decoded channel, in particular a channel regularly watched at a certain time. In this case, at this time the downloading module can download in parallel this regularly watched channel.

Obviously, the invention is not limited to the embodiment that has been described.

Thus, the decoder according to the invention notably comprises means for implementing the method according to the invention, and notably a programme memory with a first application for carrying out the channel change method.

The present invention has been described and illustrated in the present detailed description and in the figures of the appended drawings, in possible embodiments. The present invention is not limited, however, to the embodiments described. Other alternatives and embodiments may be deduced and implemented by those skilled in the art on reading the present description and the appended drawings.

In the claims, the term “comprises” does not exclude other elements or other steps. A single processor or several other units may be used to implement the invention. The different characteristics described and/or claimed may be advantageously combined. Their presence in the description or in the different dependent claims does not exclude this possibility. The reference signs cannot in any way be understood as limiting the scope of the invention.

1. A method for channel downloading for zapping from one digital channel to another digital channel in a decoding member configured to decode a channel and to transmit the channel to a screen, the decoding member comprising a downloading module comprising an activity state,
wherein the method comprises in the activity state a step of downloading a first viewing channel in an activity quality and at least one other channel in parallel with the first channel, the downloading being carried out according to an activity bit rate,
the downloading module further comprising an inactivity state having a downloading inactivity bit rate lower than the activity bit rate, wherein the method comprises in the inactivity state the steps of:
downloading the first channel in the activity quality,
receiving a signal of a channel change early warning sign,
changing the state of the downloading module by switching from the inactivity state to the activity state when the signal of a channel change early warning sign has been received.

2. The method for channel downloading according to claim 1, further comprising a step of determining an end of activity state to switch from the activity state to the inactivity state and wherein the determination step comprises different operations including:
measuring an idle period in the activity state consisting in measuring the time elapsing from a change of downloaded channel or from the reception of a signal of channel change early warning sign,
comparing the measured idle period with at least one memorised reference threshold value.

3. The method for channel downloading according to claim 1, wherein the signal of early warning sign comprises a signal sent by a remote control member to the decoding member.

4. The method for channel downloading according to claim 3, wherein the displacement sensor is an accelerometer and wherein the downloading method comprises a step of detecting a signal of early warning sign when an acceleration signal received is greater than or equal to a threshold signal representative of an acceleration of 0.3 g.

5. The method for channel downloading according to claim 3, wherein the signal of early warning sign comprises a signal originating from a measurement of the remote control sensor indicating at least an acceleration of 0.5 g or at least 1 g.

6. The method for channel downloading according to claim 3, wherein the signal of early warning sign comprises a signal of a pressing on a request button of the remote control member.

7. The method for channel downloading according to claim 1, wherein the signal of early warning sign comprises a signal received from a microphone corresponding to a key word.

8. The method for channel downloading according to claim 1, wherein in the inactivity state, the number of channels downloaded by the downloading module is a single channel.

9. The method for channel downloading according to claim 1 wherein in the inactivity state the method further comprises a step of downloading at least one other channel in parallel with the transmitted channel, the transmitted channel using a first part of the inactivity bit rate and the at least one other channel in parallel using a second part of the inactivity bit rate, and wherein the second part of the inactivity bit rate is lower than a second part of the activity bit rate for downloading at least one other channel in parallel in the activity state.

10. Method A method for broadcasting a downloaded channel to be able to send signals to command members of a display device, the broadcasting method comprising the downloading method according to claim 1 and wherein the decoding member comprises an output and the broadcasting method further comprises a step of decoding the first channel and a step of transformation into signals transmitted to the output for transmitting signals to command members of a display device for displaying the first channel.

11. Method A method for zapping from one channel to another channel comprising the broadcasting method according to claim 10, wherein the zapping method comprises the successive steps of:
receiving a signal of change of requested channel,
changing channel from the decoded channel-EN to the requested channel as a function of the signal of change of requested channel.

12. A decoding member configured to implement the downloading method according to claim 1 or/and the zapping method according to claim 11, the decoding member comprising a downloading module.

13. A computer programme product directly loadable in an internal memory of a decoding member, comprising software code portions which, when said programme is executed, lead said programme to implement the steps of the downloading method according to claim 1.

14. A non-transitory data recording support readable by a machine comprising a processor, comprising the computer programme according to claim 13.

15. An assembly comprising a decoding member according to claim 12 and a remote control member comprising an accelerometer sensor configured to send a signal of early warning sign to switch the downloading module from the inactivity state to the activity state.

16. The method for channel downloading according to claim 3, wherein the signal is a signal from a displacement sensor of the remote control member.

17. The method for channel downloading according to claim 4, wherein the acceleration is greater than 0.5 g.

18. A non-transitory computer readable medium comprising software code instructions to perform the zapping method according to claim 11.
